(19) United States
(12) Patent Application Publication
(10) Pub. No.: US 2020/0018334 A1
(43) Pub. Date: Jan. 16, 2020

(54) CLAMPING APPARATUS

(71) Applicant: Edwards Vacuum LLC, Sanborn, NY (US)

(72) Inventors: Gregory Ryan Le Mon, Hillsboro, OR (US); David Wren Dupre, Hillsboro, OR (US); Jacob Henry Goeke, Hillsboro, OR (US); Jeffrey Robert Schwab, Hillsboro, OR (US); Mark Kollin Romeo, Hillsboro, OR (US)

(21) Appl. No.: 16/032,734

(22) Filed: Jul. 11, 2018

(51) Int. Cl. F16B 2/12; F16B 2/18; F16L 23/036

(52) U.S. Cl. CPC F16B 2/12; F16L 33/12; F16L 23/036; F16B 2/185

(57) ABSTRACT

The present disclosure relates to a clamp having first and second body portions defining corresponding first and second mutually opposed engagement formations. The first and second body portions are movable relative to each other to displace the first and second engagement formations towards and away from one another. An actuator is provided for displacing the first and second engagement formations towards one another. The actuator includes a cam movably coupled to one of the first and second body portions and a cam follower coupled to the other of the first and second body portions. The cam has a cam surface for cooperating with the cam follower.

### TECHNICAL FIELD

The present disclosure relates to a clamping apparatus. More particularly, but not exclusively, the present disclosure relates to a clamp for releasably holding first and second objects, such as spools, bellows and pumps.

### BACKGROUND

In the field of fluid handling systems, it is often necessary to secure objects, such as spools, bellows and pumps, to one another. It may be necessary to secure the objects in fluid-tight engagement to inhibit the release of fluid, such as a gas. At present, attaching clamping mechanisms for vacuum systems, such as claw clamps or bolts, require the use of tools. It has been recognised that a clamp which may be operated by hand without the use of a separate tool, such as a pair of pliers, would be advantageous.

At least in certain embodiments, the present invention seeks to overcome or ameliorate at least some of the aforementioned problems.

The discussion above is merely provided for general background information and is not intended to be used as an aid in determining the scope of the claimed subject matter. The claimed subject matter is not limited to implementations that solve any or all disadvantages noted in the background.

### SUMMARY OF THE INVENTION

According to one aspect of the present invention, there is provided a clamp comprising first and second body portions defining corresponding first and second mutually opposed engagement formations, the first and second body portions being movable relative to each other to displace the first and second engagement formations towards and away from one another; and an actuator for displacing the first and second engagement formations towards one another; wherein the actuator comprises a cam movably coupled to one of the first and second body portions and a cam follower coupled to the other of the first and second body portions, the cam having a cam surface for cooperating with the cam follower.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

One or more embodiments of the present invention will now be described, by way of example only, with reference to the accompanying figures, in which:

FIG. 1A shows an isometric view of a clamp in accordance with an embodiment of the present invention;

FIG. 1B shows a side elevation of the clamp shown in FIG. 1A;

FIG. 2 shows a side elevation of a first body portion of the clamp shown in FIGS. 1A and 1B;

FIG. 3 shows an isometric view of a barrel nut for mounting to the first body portion shown in FIG. 2;

FIG. 4 shows a side elevation of an actuating arm for mounting to the barrel nut shown in FIG. 3;

FIG. 5 shows an isometric view of a second body portion of the clamp shown in FIG. 1A;

FIG. 6 shows a longitudinal sectional view of the second body portion shown in FIG. 5;

FIG. 7 illustrates the use of a plurality of the clamps to clamp annular members together;

FIG. 8 shows a side elevation of a first variant of the clamp shown in FIGS. 1A and 1B;

FIG. 9 shows a side elevation of a second variant of the clamp shown in FIGS. 1A and 1B;

FIG. 10A shows an isometric view of a clamp in accordance with a further embodiment of the present invention;

FIG. 10B shows a side elevation of the clamp shown in FIG. 10A;

FIG. 11 shows a perspective view a first body portion of the clamp shown in FIGS. 10A and 10B; and

FIG. 12 shows a perspective view a second body portion of the clamp shown in FIGS. 10A and 10B.

### DETAILED DESCRIPTION

According to one aspect of the present invention, there is provided a clamp comprising first and second body portions defining corresponding first and second mutually opposed engagement formations, the first and second body portions being movable relative to each other to displace the first and second engagement formations towards and away from one another; and an actuator for displacing the first and second engagement formations towards one another; wherein the actuator comprises a cam movably coupled to one of the first and second body portions and a cam follower coupled to the other of the first and second body portions, the cam having a cam surface for cooperating with the cam follower.

At least in certain embodiments, the clamp may be actuated by hand without the need to use a tool, such as a pair of pliers. The clamp may be referred to as a tool-less clamp. The clamp may be used to secure one or more of the following: spools, bellows, flanges, etc. In use, the cam surface and the cam follower may cooperate with each other selectively to engage and to release the clamp.

The movement of the first and second engagement formations relative to each other may comprise or consist of a translational movement. The first and second engagement formations may undergo linear translation relative to each other. The first and second body portions may be movable along a longitudinal axis. The first and second body portions may be configured to inhibit or restrict rotational movement of the first and second engagement formations relative to each other. One of the first and second body portions may be slidably received within the other of the first and second body portions. For example, the first body portion may be slidably received within the second body portion. This mounting arrangement may restrict or inhibit non-linear movement.

The cam may comprise more than one cam surface. For example, the cam may comprise first and second cam surfaces for cooperating with the cam follower. The clamp may be a double claw clamp.

The cam follower may comprise a thrust surface for cooperating with the cam surface. The thrust surface may have a profile which is substantially planar or convex. Alternatively, the thrust surface may have a profile which is concave. A concave profile may enable the cam to seat in the cam follower. In use, the cam may at least partially seat in the thrust surface. This arrangement may promote alignment of the first and second body portions.

The cam surface and the cam follower may have complimentary profiles. The cam follower may comprise a part-cylindrical thrust surface. The thrust surface may form a part of a right cylindrical surface. The cam may comprise a part-cylindrical cam surface. The cam surface may form a part of a right cylindrical surface. The part-cylindrical thrust surface may have a larger diameter than the part-cylindrical cam surface.

The cam may be coupled to the first body portion. The cam may be movably coupled to the first body portion. For example, the cam may be rotatable about a pivot axis. The pivot axis may be defined by a barrel nut. The barrel nut may form a pivot pin about which the cam rotates.

The clamp may comprise a support member for supporting the actuator. The support member may extend through and beyond the second body portion. The cam may be movably coupled to the support member. The cam may be movably coupled to a distal end of the support member. The support member may be connected to the first body portion. The support member may be formed integrally with the first body portion, or the support member may be fastened to the first body portion. Alternatively, the first body portion may be movably mounted on the support member. The support member may, for example, comprise a shoulder bolt which extends through a longitudinal aperture formed in the first body portion. The shoulder bolt may comprise a head portion for engaging the first body portion.

The cam follower may be coupled to the second body portion. The cam follower may be fixedly coupled to the second body portion. The cam follower may be formed integrally with the second body portion. Alternatively, the cam follower may be movably coupled to the second body portion.

The cam may be eccentrically mounted. The cam may be an eccentrically mounted circular cam.

The cam may be rotatable about a rotation axis extending perpendicular to a longitudinal axis of the clamp.

An actuating arm may be coupled to the cam. The actuating arm may form a lever for manually actuating the clamp. The actuating arm may comprise a base portion and a distal portion. The distal portion may be inclined at an oblique angle relative to the base portion. The distal portion may be inclined at an angle in the range 120° to 150° relative to the base portion.

The clamp may comprise a resilient bias member for biasing the first and second engagement formations towards one another.

The clamp may comprise a resilient bias member for biasing the first and second engagement formations away from one another. The resilient bias member may comprise a compression spring disposed between the first body portion and the second body portion. The resilient bias member may bias the clamp towards an open position for facilitating installation.

The first engagement formation may comprise a first front face having a concave profile. Alternatively, or in addition, the second engagement formation may comprise a second front face having a concave profile.

The first and second mutually opposed engagement formations may comprise respective first and second recess formations for engaging flanges of first and second fluid conduits.

The first engagement formation may comprise a first engagement recess having a first arcuate profile. Alternatively, or in addition, the second engagement formation may comprise a second engagement recess having a second arcuate profile. The first arcuate profile and/or the second arcuate profile may be configured for cooperating with an annular member, such as an annular lip or flange.

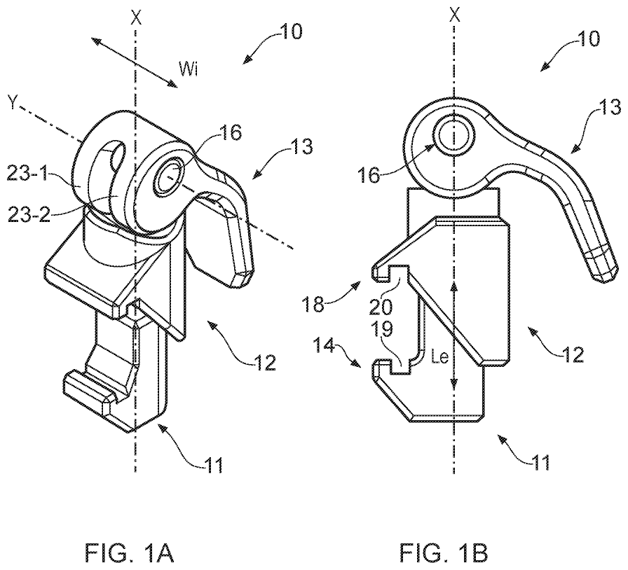

A clamp according to an embodiment of the present invention is designated generally by reference numeral 10, as shown in FIGS. 1A and 1B. In the present embodiment, the clamp 10 is a double claw clamp. The clamp 10 is described herein in relation to the orientation shown in FIG. 1A. It will be understood that the clamp 10 is not limited to operation in this orientation and the use herein of relative positional terms, such as “upper”, “upwardly”, “lower”, “downwardly” etc., are not to be understood as being limiting.

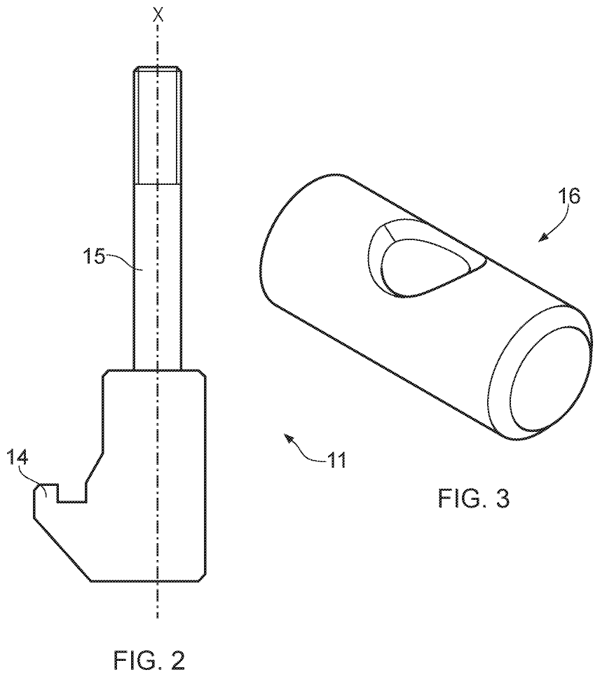

The clamp 10 in the present embodiment is a claw clamp. As shown in FIGS. 1A and 1B, the clamp 10 comprises a first body portion 11, a second body portion 12 and an actuator 13. The first body portion 11 comprises a first engagement formation 14, a support member 15 and a barrel nut 16 (shown in FIG. 3). As shown in FIG. 2, the support member 15 is an elongated member extending along a longitudinal axis X of the clamp 10. The support member 15 in the present embodiment comprises a cylindrical rod. The first engagement formation 14 is disposed at a first end of the support member 15 and the barrel nut 16 is disposed at a second end of the support member 15. The second body portion 12 comprises a second engagement formation 18. The first and second engagement formations 14, 18 are mutually opposed to each other. In the present embodiment, the first and second engagement formations 14, 18 comprise respective first and second recess formations 19, 20. The first and second recess formations 19, 20 form slots or channels extending widthwise across the first and second engagement formations 14, 18. In other embodiments of the invention (not shown) one or more of the recess formations may be omitted and/or they may take a different form.

The first body portion 11 and the second body portion 12 are movable relative to each other along the longitudinal axis X of the clamp 10. The longitudinal axis X extends in a lengthwise direction Le relative to both the first and second body portions 11, 12. The first body portion 11 is slidably received within the second body portion 12 in a manner that restrains movement of the first and second engagement formations towards and away from one another in a linear direction. In the present embodiment, the first body portion 11 has a substantially rectangular cross-sectional profile which is received within a complimentary, substantially rectangular open channel cross-sectional profile of the second body portion 12. In such a way the first and second body portions 11, 12 are restrained from moving in a widthwise direction Wi relative to one another, as well as from rotating relative to one another about the longitudinal axis X. It will be understood that the first body portion 11 and the open channel of the second body portion 12 may have other non-circular cross-sectional profiles for restraining relative movement in the widthwise direction Wi as well as rotational movement about the longitudinal axis X. The first and second body portions 11, 12 are able to move in the said lengthwise direction Le relative to one another, so as to provide for the said restrained linear movement of the first and second engagement formations 14, 18 towards and away from one another.

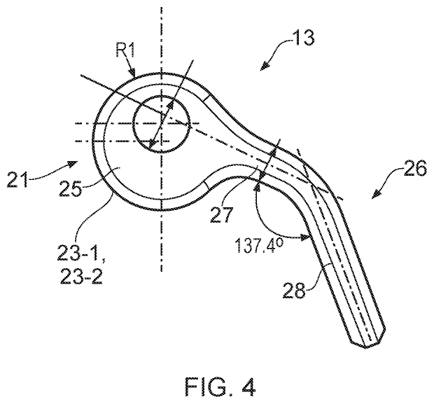

As shown in FIG. 4, the actuator 13 comprises a cam 21 movably coupled to the first body portion 11. The cam 21 is arranged to cooperate with a cam follower 22 formed on the second body portion 12. The cam 21 comprises first and second cam surfaces 23-1, 23-2 for engaging a thrust surface 24 of the cam follower 22. The first and second cam surfaces 23-1, 23-2 are formed by an outer surface of a cylindrical portion 25 of the cam 21. The cylindrical portion 25 in the present embodiment comprises a right circular cylinder. The cam 21 is a circular cam having a first radius R1. In the present embodiment the first radius R1 is 11.1 mm. The cam 21 is eccentrically mounted and is rotatable about a pivot axis Y defined by the barrel nut 16 mounted to the support member 15. It will be understood that the cylindrical portion 23 may have other profiles, for example an elliptical profile.

An actuating arm 26 is connected to the cam 21 to form a lever for manual actuation of the clamp 10 without the use of a tool, such as Cleco® pliers. The actuating arm 26 in the present embodiment is formed integrally with the cam 21. The actuating arm 26 comprises a base portion 27 connected to the cam 21; and a distal portion 28. As shown in FIG. 4, the distal portion 28 of the actuating arm 26 is inclined at an oblique angle relative to the base portion 27. In the present embodiment, the distal portion 28 is inclined at an oblique angle of approximately 137° relative to the base portion 27. In the orientation illustrated in FIG. 1A, the distal portion 28 is inclined downwardly to extend towards the second body portion 12. Thus, the actuating arm 26 has a non-linear configuration which enables the actuating arm 26 to be positioned closer to the second body portion 12 when clamp 10 is closed. The distal portion 28 of the actuating arm 26 may be disposed proximal to or against the second body portion 12 when the clamp 10 is closed. At least in certain embodiments, this may reduce the possibility of the clamp 10 loosening or opening accidentally, for example due to bumping or vibration in use.

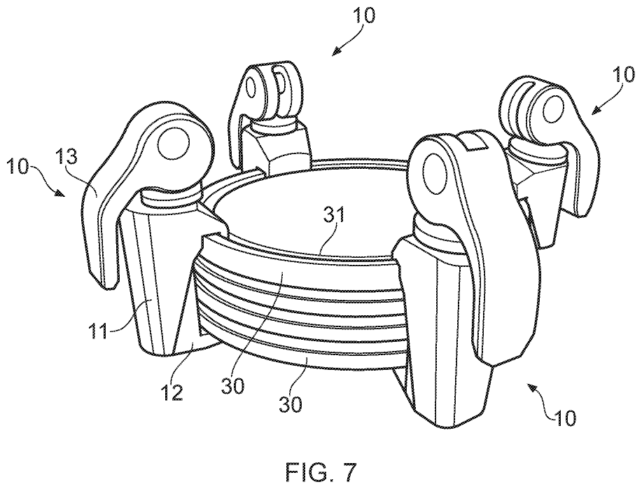

As shown in FIGS. 6 and 7, the second body portion 12 comprises a central aperture 29 extending along the longitudinal axis X of the clamp 10. The support member 15 of the first body portion 11 extends through the central aperture 29. The cam follower 22 is formed integrally with an upper surface of the second body portion 12. The cam follower 22 forms the thrust surface 24 at the upper end of the second body portion 12. The thrust surface 24 has a part-cylindrical concave profile. The concave profile of the cam follower 22 forms a cam seat for seating at least a portion of the cam 21. The thrust surface 24 in the present embodiment comprises a right cylindrical surface having a second radius R2. The second radius R2 is larger than the first radius R1. In the present embodiment the second radius R2 is 12.5 mm. In a modified arrangement, the cam follower 22 could be a separate component mounted to the second body portion 12.

In the present embodiment, the connection between the barrel nut 16 and the support member 15 comprises cooperating threads which enable the longitudinal position of the barrel nut 16 to be adjusted to alter the effective length of the first body portion 11. In use, the distance between the first and second body portions 11, 12 when the clamp 10 is closed may be adjusted by altering the position of the barrel nut 16 on the support member 15. A locking member, such as a locking nut, may be provided on the support member 15 to lock the longitudinal position of the barrel nut 16.

The operation of the clamp 10 will now be described. The actuating arm 26 is rotated about the pivot axis Y in an upwards direction (in the orientation shown in FIG. 1A) to open the clamp 10. The cam 21 is rotated about the pivot axis Y to reduce the clamping force applied to the cam follower 22 by the first and second cam surfaces 23-1, 23-2, thereby enabling the second body portion 12 to translate in an upward direction. The first and second engagement formations 14, 18 may be displaced away from each other, thereby opening the clamp 10. One or more object may be located between the first and second engagement formations 14, 18. The actuating arm 26 is rotated about the pivot axis Y in a downwards direction (in the orientation shown in FIG. 1A) to close the clamp 10. The cam 21 is rotated about the pivot axis Y such that the first and second cam surfaces 23-1, 23-2 apply a clamping force to the cam follower 22. The rotation of the cam 21 displaces the second body portion 12 towards the first body portion 11 (in a downwards direction in the orientation shown in FIG. 1A). The first and second engagement formations 14, 18 are displaced towards each other, thereby closing the clamp 10. The continued rotation of the actuating arm 26 increases the clamping force applied to the cam follower 22.

One or more clamp 10 of the type described herein may be used to clamp the ends of first and second conduits together. The first and second conduits may have respective first and second end flanges which are aligned with each other. The first and second end flanges are located between the first and second engagement formations 14, 18. The actuating arm 26 is operated to apply a clamping force to the first and second end flanges, thereby clamping the first and second conduits together. At least in certain embodiments, the clamping force applied by the clamp 10 may form a fluid-tight seal between the first and second fluid conduits. The first and second end flanges may comprise formations for locating in the first and second recess formations 19, 20 formed in the first and second engagement formations 14, 18. The formations may, for example, comprise one or more protuberance, or an annular ridge.

The use of four (4) of the clamps 10 to clamp a stack of circular members 30 together is shown in FIG. 7. The circular members 30 each comprise an annular channel 31. In use, the first and second engagement formations 14, 18 formed on the first and second body portions 11, 12 locate within the annular channels 31. The clamps 10 are closed to apply a clamping force to the circular members 30. To facilitate location in the annular channels 31, each of the first and second engagement formations 14, 18 may comprise a concave front face. Alternatively, or in addition, the first recess formation 19 and/or the second recess formation 20 may comprise an arcuate channel for receiving an annular rim of the circular members 30.

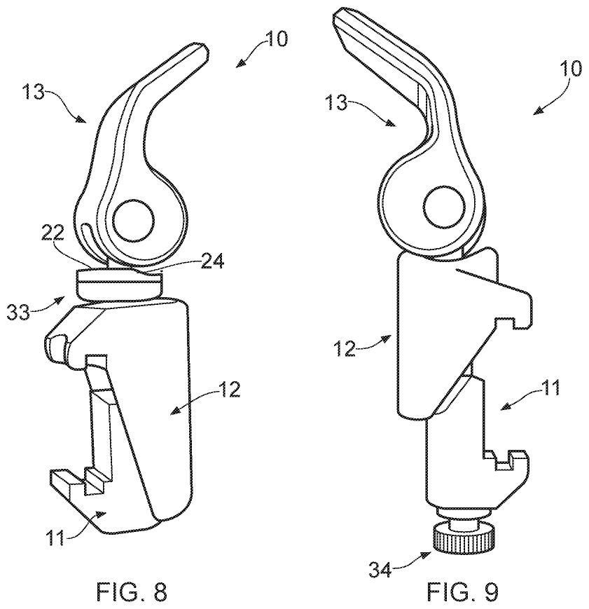

A first variant of the clamp 10 according to the present invention is shown in FIG. 8. Like reference numerals are used for like components. The clamp 10 illustrated in FIGS. 1A and 1B comprises a cam follower 22 which is formed integrally with the second body portion 12. In the variant shown in FIG. 8, the cam follower 22 is formed by a floating plate 33 disposed on the support member 15 of the first body portion 11. The cam follower 22 forms the thrust surface 24 for cooperating with the first and second cam surfaces 23-1, 23-2.

A second variant of the clamp 10 according to the present invention is shown in FIG. 9. Like reference numerals are used for like components. In the second variant, the length of the first body portion 11 is adjustable. In particular, the support member comprises a thumb wheel 34 (disposed at the bottom of the support member 15 in the orientation shown in FIG. 9) for adjusting the length of the first body portion 11. The thumb wheel 34 is rotatable on a threaded section (not shown) of the support member 15. By adjusting the length of the first body portion 11, the clamping force applied by the clamp 10 may be adjusted. Other mechanisms may be used to adjust the length of the first body portion 11. The section of the first body portion 11 forming the first engagement formation 14 may be movable in a lengthwise direction along the support member 15. A resilient bias member, such as a compression spring, may be provided between the thumb wheel 34 and the first body portion 11.

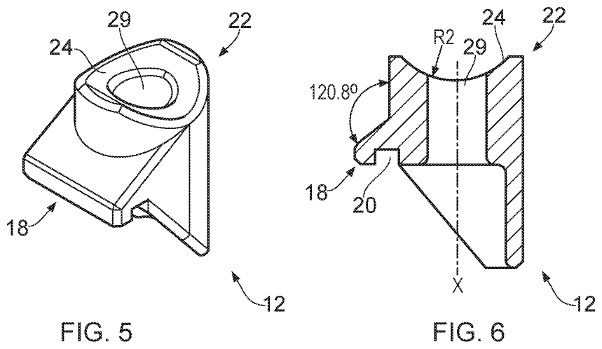

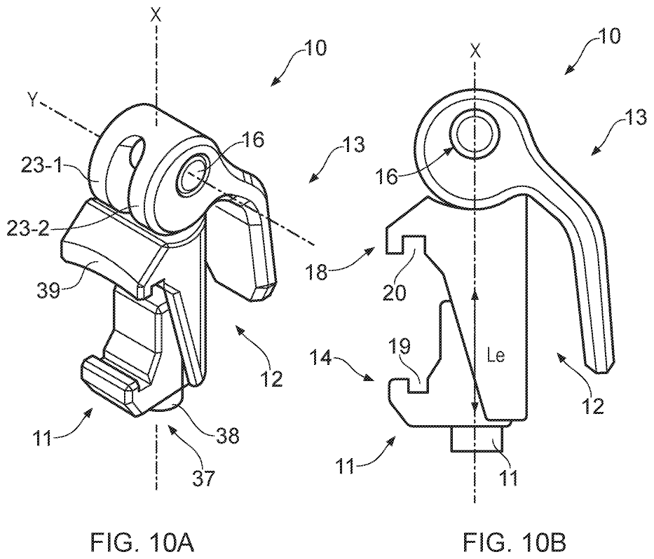

A further embodiment of the clamp 10 according to the present invention is shown in FIGS. 10A, 10B, 11 and 12. The clamp 10 according to this embodiment is a development of the embodiment described herein with reference to FIGS. 1 to 9. Like reference numerals are used for like components.

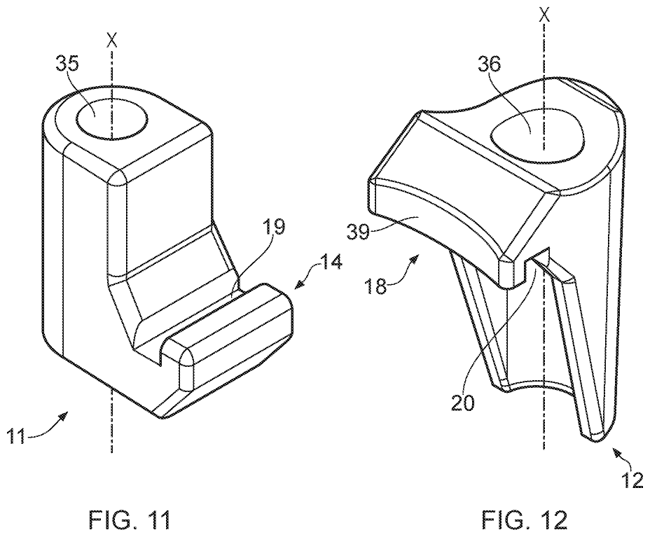

As shown in FIGS. 10A and 10B, the clamp 10 comprises a first body portion 11 and a second body portion 12 movable relative to each other along a longitudinal axis X. The clamp 10 comprises an actuator 13 which is unchanged from the above embodiment. A perspective view of the first body portion 11 is shown in FIG. 11; and a perspective view of the second body portion 12 is shown in FIG. 12. The first and second body portions 11, 12 comprise respective first and second engagement formations 14, 18. The first body portion 11 in the present embodiment comprises a first central aperture 35 extending along the longitudinal axis X. The second body portion 12 comprises a second central aperture 36 extending along the longitudinal axis X. The first and second central apertures 35, 36 are disposed coaxially and are configured to receive a shoulder bolt 37. The shoulder bolt 37 is a variant of the support member 15 which is connected to the first body portion 11 in the above embodiment. The shoulder bolt 37 comprises a head portion 38 disposed at a first end of the shoulder bolt 37 for engaging a lower surface of the first body portion 11. A threaded portion (not shown) is formed at a second end of the shoulder bolt 37 for mounting a barrel nut 16 which pivotally mounts the actuator 13. The use of a shoulder bolt 37 enables the position of the barrel nut 16 to be set at the required height. This may increase repeatability during the manufacturing process.

As shown in FIG. 12, a front face 39 of the second engagement formation 18 formed on the second body portion 12 comprises a concave profile. The concave profile of the front face 39 facilitates location of the in an annular channel, for example of the type formed in the circular member shown in FIG. 7. Alternatively, or in addition, the first engagement formation 14 may comprise a front face having a concave profile. Alternatively, or in addition, at least one of the first and second recess formations 19, 20 may comprise an arcuate channel for receiving a rim portion of a circular member.

The clamp 10 may optionally comprise a resilient bias member for biasing the first and second body portions 11, 12 away from each other. The resilient bias member may comprise a compression spring disposed between the first body portion 11 and the second body portion 12. The compression spring may be installed around the shoulder bolt 37 and locate between the first and second body portions 11, 12. The resilient bias member may bias the clamp 10 towards an open position, thereby facilitating installation. At least in certain embodiments, the resilient bias member may be provided without inhibiting closure of the clamp 10. The resilient bias member may control or limit a clamping force applied by the clamp 10.

It will be understood that various changes and modifications may be made to the clamp 10 described herein without departing from the scope of the present application.

The clamp 10 may, for example, comprise a resilient bias member for biasing the first and second engagement formations 14, 18 towards each other or away from each other. The resilient bias member may comprise a resilient spring member. The resilient spring member may comprise a compression spring disposed between the first body portion 11 and the second body portion 12 to bias the first and second engagement formations 14, 18 away from each other. Alternatively, the resilient spring member may comprise a compression spring disposed between the second body portion 12 and the actuator 13 to bias the first and second engagement formations 14, 18 towards each other. In this arrangement, the cam follower 22 may, for example, comprise a movable thrust plate disposed on the second body portion 12.

In a variant, the actuator 13 could be configured to displace the first and second engagement formations 14, 18 away from one another. For example, the actuator 13 could operate against a spring bias member to open the clamp 10. The spring bias member may be configured to bias the first and second engagement formations 14, 18 towards each other. The actuator 13 may be released to enable the first and second engagement formations 14, 18 to move towards each other under the action of the spring bias member, thereby closing the clamp 10.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above.

1. A clamp comprising:
first and second body portions defining corresponding first and second mutually opposed engagement formations, the first and second body portions being movable relative to each other to displace the first and second engagement formations towards and away from one another; and
an actuator for displacing the first and second engagement formations towards one another;
wherein the actuator comprises a cam movably coupled to one of the first and second body portions and a cam follower coupled to the other of the first and second body portions, the cam having a cam surface for cooperating with the cam follower.

2. The clamp as claimed in claim 1, wherein the cam follower comprises a thrust surface for cooperating with the cam surface.

3. The clamp as claimed in claim 2, wherein the thrust surface has a concave profile for seating the cam.

4. The clamp as claimed in claim 2, wherein the cam follower comprises a part-cylindrical thrust surface.

5. The clamp as claimed in claim 4, wherein the cam surface comprises a part-cylindrical cam surface, the part-cylindrical thrust surface having a larger diameter than the part-cylindrical cam surface.

6. The clamp as claimed in claim 1, wherein the cam is movably coupled to the first body portion and the cam follower is coupled to the second body portion.

7. The clamp as claimed in claim 1 comprising a support member which extends through and beyond the second body portion, the cam being movably coupled to the support member.

8. The clamp as claimed in claim 1, wherein the cam is eccentrically mounted.

9. The clamp as claimed in claim 1, wherein the cam is rotatable about a rotation axis (Y) extending perpendicular to a longitudinal axis (X) of the clamp.

10. The clamp as claimed in claim 1, wherein an actuating arm is coupled to the cam.

11. The clamp as claimed in claim 10, wherein the actuating arm comprises a base portion and a distal portion, the distal portion of the actuating arm being inclined at an oblique angle relative to the base portion.

12. The clamp as claimed in claim 1 comprising a resilient bias member for biasing the first and second engagement formations towards one another.

13. The clamp as claimed in claim 1 comprising a resilient bias member for biasing the first and second engagement formations away from one another.

14. The clamp as claimed in claim 1, wherein the first and second engagement formations comprise respective first and second recess formations for engaging flanges of first and second fluid conduits.

15. The clamp as claimed in claim 1, wherein the first engagement formation comprises a first front face having a concave profile; and/or the second engagement formation comprises a second front face having a concave profile.

16. The clamp as claimed in claim 1, wherein the first engagement formation comprises a first engagement recess having a first arcuate profile; and/or the second engagement formation comprises a second engagement recess having a second arcuate profile.
